(19) United States
(12) Patent Application Publication
(10) Pub. No.: US 2015/0021511 A1
(43) Pub. Date: Jan. 22, 2015

(54) ORGANIC/INORGANIC NANOCOMPOSITE CAPABLE OF ADSORPTION/DESORPTION OF METAL IONS, AND PREPARATION METHOD THEREOF

(71) Applicant: Industry-Academic Cooperation Foundation, Yonsei University, Seodaemun-gu, Seoul (KR)

(72) Inventors: Jung Hyun Kim, Seoul (KR); Yong Seok Kim, Seongnam-si Gyeonggi-do (KR); In Woo Cheong, Suseong-gu Daegu (KR)

(73) Assignee: INDUSTRY-ACADEMIC COOPERATION FOUNDATION, YONSEI UNIVERSITY, Seodaemun-gu, Seoul (KR)

(21) Appl. No.: 14/375,597

(22) PCT Filed: Sep. 28, 2012
(86) PCT No.: PCT/KR2012/007883

§ 371 Date: Jul. 30, 2014

(30) Foreign Application Priority Data
Jan. 31, 2012 (KR) 10-2012-0009953

(51) Int. Cl. B01J 39/04; H01F 1/03

(52) U.S. Cl. CPC B01J 39/046; H01F 1/03
USPC 252/62.54

(57) ABSTRACT

The present invention relates to an organic-inorganic nanocomposite comprising a polymer having temperature dependent volume phase transition characteristics, and magnetic particles embedded in the polymer, and a preparation method thereof. The present invention induces more rapid adsorption and desorption of metal ions and can effectively recover the used organic-inorganic nanocomposite.

### CROSS-REFERENCE TO RELATED APPLICATION

This application claims priority to and the benefit of Korean Patent Application No. 2012-0009953, filed on Jan. 31, 2012, the disclosure of which is incorporated herein by reference in its entirety.

### BACKGROUND

1. Field of the Invention

The present invention relates to an organic-inorganic adsorbent nanocomposite which can selectively adsorb and desorb metal ions, and a preparation method thereof.

2. Discussion of Related Art

Studies for scavenging metal ions dispersed in various solvents have been continuously conducted. In the method for scavenging metal ions, various systems are present, and examples thereof include a co-precipitation method, a floatation method, a solvent extraction method, a bio-enrichment method, an adsorption method, and the like. Among them, a promising method for gathering useful metals in seawater to be treated as a large amount of solution is an adsorption method.

The adsorption method is, for example, a system of adsorbing metal ions using an inorganic adsorbent. However, there is a problem in that the inorganic adsorbent has excellent adsorption performance, whereas it is difficult to mold the inorganic adsorbent, and the durability thereof is weak. Further, in order to desorb metal ions adsorbed on the inorganic adsorbent, an ion exchange system using an acid treatment is generally used. The chemical treatment system may cause various problems from the environmental vie point, and there is a limitation in which it is limited to re-use of a used inorganic adsorbent.

### SUMMARY OF THE INVENTION

1. Technical Problem

The present invention has been made in an effort to provide an organic-inorganic nanocomposite comprising a polymer having temperature dependent volume phase transition characteristics, and magnetic particles embedded in the polymer, and a preparation method thereof.

2. Technical Solution

An exemplary embodiment of the present invention provides an organic-inorganic nanocomposite including a polymer having temperature dependent volume phase transition characteristics, and magnetic particles embedded in the polymer.

Further another exemplary embodiment provides a method of preparing the organic-inorganic nanocomposite, the method including: preparing magnetic particles; and

mixing the prepared magnetic particles with a polymer having temperature-dependent volume phase transition characteristics.

3. Advantageous Effects

The organic-inorganic nanocomposite according to the present invention induces more rapid adsorption and desorption for metal ions, and can effectively recover the used organic-inorganic composite.

### BRIEF DESCRIPTION OF THE DRAWINGS

The above and other objects, features, and advantages of the present invention will become more apparent to those of ordinary skill in the art by describing in detail exemplary embodiments thereof with reference to the attached drawings, in which:

FIG. 1 is a schematic view illustrating a process of preparing an organic-inorganic adsorbent capable of selectively adsorbing metal ions according to an exemplary embodiment of the present invention.

FIG. 2 is a SEM photograph of an organic-inorganic adsorbent capable of selectively adsorbing metal ions according to an exemplary embodiment of the present invention.

FIG. 3 is a TEM photograph of an organic-inorganic adsorbent capable of selectively adsorbing metal ions according to an exemplary embodiment of the present invention.

FIG. 4 illustrates an aspect of recovering an organic-inorganic adsorbent capable of selectively adsorbing metal ions according to an exemplary embodiment of the present invention with a permanent magnet.

FIG. 5 illustrates an aspect of a change in volume of organic-inorganic adsorbent capable of selectively adsorbing metal ions according to an exemplary embodiment of the present invention.

FIG. 6 is a graph illustrating the degrees of adsorption and desorption of an organic-inorganic adsorbent capable of selectively adsorbing metal ions according to the present invention in virtual seawater for each metal component.

FIG. 7 is a graph illustrating the selectivity of an organic-inorganic adsorbent capable of selectively adsorbing metal ions according to the present invention in virtual seawater for each metal component.

### DETAILED DESCRIPTION OF EXEMPLARY EMBODIMENTS

In an exemplary embodiment, an organic-inorganic nanocomposite according to the present invention may include a polymer having temperature dependent volume phase transition characteristics, and magnetic particles embedded in the polymer.

The organic-inorganic nanocomposite may induce more rapid adsorption and desorption of metal ions using a polymer having a temperature dependent volume change. In addition, the used nanocomposite may he effectively recovered using magnetic particles included in the organic-inorganic nanocomposite. Since a limitation of using a strong acid, which the existing adsorbent has, is overcome in order to desorb adsorbed metals, and simultaneously, it is easy to recover the used composite, an effect of resource recycling and environmental protection n ay be obtained by this.

The polymer is not particularly limited in type as long as the polymer is a polymer having temperature dependent volume phase transition (VPT) characteristics. The polymer having temperature dependent volume phase transition characteristics in the present invention collectively refers to the ease where the volume of the polymer varies depending on a change in temperature. As an example of the polymer, one or more of an amide-based polymer and a vinyl-based polymer may be used. For example, the polymer may be one or more selected from the group consisting of N-isopropylacrylamide, N-isopropylmethacrylamide, N-n-propylacrylamide, N-tertbutylacrylamide, dimethylaminopropyl methacrylamide, N,N-dimethylacetamide, dimethylacetamide, ethanamide, acetamide, phosphonamide, sulfonamide, N,N-dimethylformamide, and derivatives thereof.

The derivative may be one substituted with one or more substituents selected from the group consisting of an alkyl group, an amine group, an imine group, an ethoxy group, and a carboxylic group, but is not limited thereto. The carbon number of an alkyl group and the like is not particularly limited, and may be a carbon number of 1 to 6.

As another example, the polymer having temperature dependent volume phase transition characteristics may further include a selective adsorption functional group for metal ions wherein the selective adsorption functional group is copolymerized with the polymer. The selective adsorption functional group for metal ions is not particularly limited in type, and a crown ether group may be used. Examples of the crown ether group include one or more selected from the group consisting of 15-crown-5-ether, 18-crown-6-ether, 12-crown-4-ether, 24-crown-8-ether, and derivatives thereof. Furthermore, it is possible to enhance the adsorption rate and efficiency by adjusting the size of the selective adsorption functional group on as to be similar to the size of the metal ion. By further including a selective adsorption functional group for metal ions, the degree of adsorption for a specific metal may be increased, and only a desired metal. may be selectively recovered.

The organic-inorganic nanocomposite according to the present invention includes magnetic particles. The magnetic particle collectively refers to a particulate material having properties of attracting metal components under the environment to which the magnetic field is applied, and examples thereof include a metal, a magnetic material, a magnetic alloy, and the like.

As an example, the metal may be one or more selected from the group consisting of Pt, Pd, Ag, Cu, and Au. The magnetic material may be one or more selected from the group consisting of Co, Mn, Fe, Ni, Gd, Mo, MM′₂O₄, and MₓO_{y} (M and M′ independently denote Co, Fe, Ni, Mn, Zn, Gd, or Cr, and 0<x≦3 and 0<y≦5). Further, the magnetic alloy may be one or more selected from the group consisting of CoCu, CoPt, FePt, CoSm, NiFe, and NiFeCo. For example, the magnetic particle may be one or more selected from the group consisting of Fe₂O₃, Fe₃O₄, and derivatives thereof, or have a structure in which the component is coated with an organic material.

The average diameter of the magnetic particle is not particularly limited, and may be, for example, in a range of 3 nm to 25 nm, 1 nm to 20 nm, or 5 nm to 10 nm.

The organic-inorganic adsorbent according to the present invention may be, for example, monodispersive with a spherical or elliptical shape. Herein, the spherical shape includes not only the case where a mathematically perfect sphere is formed, but also an error range that occurs during the process of measurement and preparation. Further, a monodispersive uniform component may be formed, and in some cases, the polydispersity such as bidispersity and tridispersity may be formed.

The average particle size of the organic-inorganic adsorbent is not particularly limited, and may be, for example, in a range of 100 nm to 100 μm, 200 nm to 50 μm, or 300 nm to 3 μm.

In addition, the present invention provides a method for preparing the aforementioned organic-inorganic nanocomposite.

The preparation method may include: preparing magnetic particles; and preparing a polymer having temperature dependent volume phase transition characteristics, in which the prepared magnetic particles are embedded.

The method for preparing magnetic particles is not particularly limited, and for example, it is possible to apply a method of using a ligand exchange method to modify magnetic particles modified with an aliphatic acid using a co-precipitation method, a thermal decomposition method, a micro-emulsion method, or a hydrothermal synthetic method, and the like. As the method for preparing magnetic particles, various methods known in the art can all be applied.

As an example, the preparing of a polymer having temperature dependent volume phase transition characteristics, in which the prepared magnetic particles are embedded, may include a process of mixing magnetic particles; and one or more selected from the group consisting of a vinyl-based monomer and an acrylic-based monomer to perform the polymerization.

As an example, the preparing of a polymer having temperature dependent volume phase transition characteristics, in which the prepared magnetic particles are embedded, may include a process of mixing magnetic particles; one or more selected from the group consisting of a vinyl-based monomer and an acrylic-based monomer; and a selective adsorption functional group for metal ions to perform the polymerization.

The selective adsorption functional group for metal ions may be synthesized, for example, by synthesizing a crown ether monomer and methacryloyl chloride in a solvent phase, and then separating and purifying the resulting product. The crown ether monomer is not particularly limited in type, and may be, for example, one or more selected from the group consisting of 15-crown-5-ether, 18-crown-6-ether, 12-crown-4-ether, 24-crown-8-ether, and derivatives thereof.

As another example, the preparing of a polymer having temperature dependent volume phase transition characteristics, in which the prepared magnetic particles are embedded, may be performed by additionally adding one or more selected from the group consisting of a cross-linking agent, an emulsifier, a dispersion medium, and a polymerization initiator thereto.

The cross-linking agent is not particularly limited in type, and may be, for example, one or more selected from the group consisting of 1,5-difluoro-2,4-dinitrobenzene, tris-succinimidyl aminotriacetate, ethylene glycol bis[sulfosuccinimidylsuccinate], 3,3′-dithiobis[sulfosuccinimidylpropionate], disuccinimidyl tartarate, dithiobis(succinimidyl) propionate, disuccinimidyl glutarate, bis[2-(succinimidooxycarbonyloxy)ethyl]sulfone, bis(sulfosuccinimidyl) suberate, bis(succunimidyl) penta(enthylene glycol), N,N′-methylene-bis-acrylamide, and derivatives thereof. The content of the cross-linking agent may be, for example, 0.005 to 1 part by weight based on 100 parts by weight of an amide-based and/or acrylic-based monomer. Within the content range of the cross-linking agent, the synthesized particles may be maintained in a stable form.

During the process of polymerizing the particles, the emulsifier may not be used, but emulsion polymerization may also be performed. The emulsifier is not particularly limited in type, and may be, for example, one or more selected from the group consisting of sodium dodecyl sulfonate, sodium lauryl sulfonate, decanoic acid, n-dodecyl mercaptan (DDM), alkyl methacrylate, dodecyl methacrylate (DMA), stearyl methacrylate (SMA), sodium dodecylbenzenesulfonate, and derivatives thereof. The content of the emulsifier may be, for example, in a range of 0.005 to 1 part by weight based on 100 parts by weight of an amide-based and/or acrylic-based monomer. By using the emulsifier in the range, the size of synthesized particles may be increased, and stability may be maintained.

The dispersion medium is water, an organic solvent, or a mixture thereof, and may be, specifically, one or more selected from the group consisting of distilled deionized water (DDI water), acetone, C₁₋₅ alcohols, acetic acid, and a mixed solvent thereof. The content of the dispersion medium may be, for example, in a range of 600 to 1,600 parts by weight based on 100 parts by weight of a vinyl-based and/or acrylic-based monomer. By using the dispersion medium in the range, the synthesized particles may maintain monodispersibility.

When the dispersion medium and the emulsifier are mixed, the mixture may be stirred at a rate of, for example, 100 to 350 rpm.

As the polymerization initiator, for example, one or more selected from the group consisting of potassium persulfate, azobisisobutyronitrile (AIBN), K₂S₂O₈, BPO, ADVN, AMBN, (NH₄)₂S₂O₈, and Na₂S₂O₈ may be used. For example, the polymerization initiator may be added during the soap-free emulsion polymerization. The content of the polymerization initiator may be 0.03 to 1 part by weight based on 100 parts by weight of a vinyl-based and/or acrylic-based monomer.

The preparing of a polymer having temperature dependent volume phase transition characteristics, in which the prepared magnetic particles are embedded, may be performed through a radical polymerization of a raw material component. The step may be performed, for example, at 60 to 90° C. for 2 to 6 hours. By the preparation method according to the present invention, spherical particles are formed after the radical polymerization reaction, and magnetic particles are fixed in the spherical particles through the chemical bonds.

The present invention also provides a metal re-treatment system including the process of adsorbing and desorbing metals or metal ions using the aforementioned organic-inorganic nanocomposite. The metal re-treatment system collectively refers to various methods and devices including the process of recovering the corresponding metal component through the process of adsorbing and desorbing the metal component contained in a solvent, and the like. Further, in the present invention, the aforementioned organic-inorganic nanocomposite may be used as an adsorbent which adsorbs metals or metal ions.

As an example, the organic-inorganic nanocomposite according to the present invention may be used as an organic-inorganic adsorbent which may selectively adsorb metal ions present in an aqueous phase. In particular, the nanocomposite may be utilized for the use of recovering metal ions from seawater or selectively adsorbing metal ions from wastewater discharged from industrial plants. For example, the nanocomposite may be utilized for the use of recovering lithium from seawater.

Furthermore, it is possible to use a technology of taking the lid of a capsule off by adding a drug to an alkali on scavenger, a phase-transfer catalyst in the organic synthesis, a mobile phase additive for separating amines in the liquid chromatography, and a nano-sized capsule, and sending the resulting assembly to a target place to emit light in a drug delivery system.

Hereinafter, the present invention will be described in more detail with reference to Examples. However, the scope of the present invention is not limited to Examples and Experimental Example provided below.

### EXAMPLE 1

### Preparation of Monodispersive Organic-Inorganic Nanocomposite

(1) Preparation of Magnetic Particles

4.1 g of FeCl₃.6H₂O (Sigma Aldrich, Inc.) and 2.35 g of FeSO₄.7H₂O were mixed with 100 ml of distilled deionized water at 80° C., and then purged with nitrogen to remove oxygen. The reaction solution was stirred at a high rate of 600 rpm or more, and reduced with 25 ml of ammonia water to precipitate a solid, and then the surface of the material was modified with 1 ml of oleic acid (Sigma Aldrich, Inc). The completely surface-modified material was stirred at 80° C. for 1 hour to prepare a magnetic solution.

3 g of sodium chloride was mixed with a mixture of 50 ml of the magnetic solution and 50 ml of toluene, and then a reparatory funnel was used to remove uncoated magnetic particles and extra oleic acid. Then, the remaining distilled water was refluxed at 70° C. to completely remove the distilled water, thereby preparing a magnetic particle solution.

10 ml of the magnetic particle solution and 1 ml of 3-(methacryloxypropyl) trimethoxysilane were mixed with 8 ml of triethylamine mixed with toluene at a ratio of 2 M. The mixed solution prepared was subjected along with nitrogen gas to a ligand exchange method at room temperature for 48 hours to synthesize magnetic particles including a silane group. The magnetic particles were purified using petroleum ether at a ratio of 1:1 to prepare a magnetic nano particle magnetite. The average particle diameter of the prepared particles was measured in a range of 3 to 15 nm.

(2) Synthesis of Metal Adsorption Functional Group

0.825 g of hydroxymethyl 12-crown-4 (Sigma Aldrich, Inc.), 0.6 ml of triethylamine (Sigma Aldrich, Inc.), and 20 ml diethyl ether (Sigma Aldrich, Inc.) were mixed. 0.8 ml of methacryloyl chloride (Sigma Aldrich, Inc.) was reacted with the prepared mixture in a low temperature state, and then the resulting product was subjected to purification process with diluted hydrochloric acid. Water was removed over magnesium sulfate from the reactant subjected to the purification process, and then an evaporator was used to remove the solvent, and about 0.73 g of a lithium adsorption functional group solution was synthesized therefrom.

(3) Preparation of Organic-Inorganic Nanocomposite

A mixed solution, in which 0.5 g of N-isopropylacrylamide (Sigma Aldrich, Inc.). 0.3 g of a lithium adsorption functional group, 0.010 g of N,N-methylenebisacrylamide, and 35 ml of distilled water were mixed, was prepared. 0.05 g of 2,2-azobisisobutyronitrile in 5 ml of acetone was mixed with the magnetic particles, and then added to the mixed solution, and the resulting solution was polymerized at 70° C. for 4 hours to prepare an organic-inorganic nanocomposite. The number average particle size of the prepared organic-inorganic nanocomposite was about 270 nm.

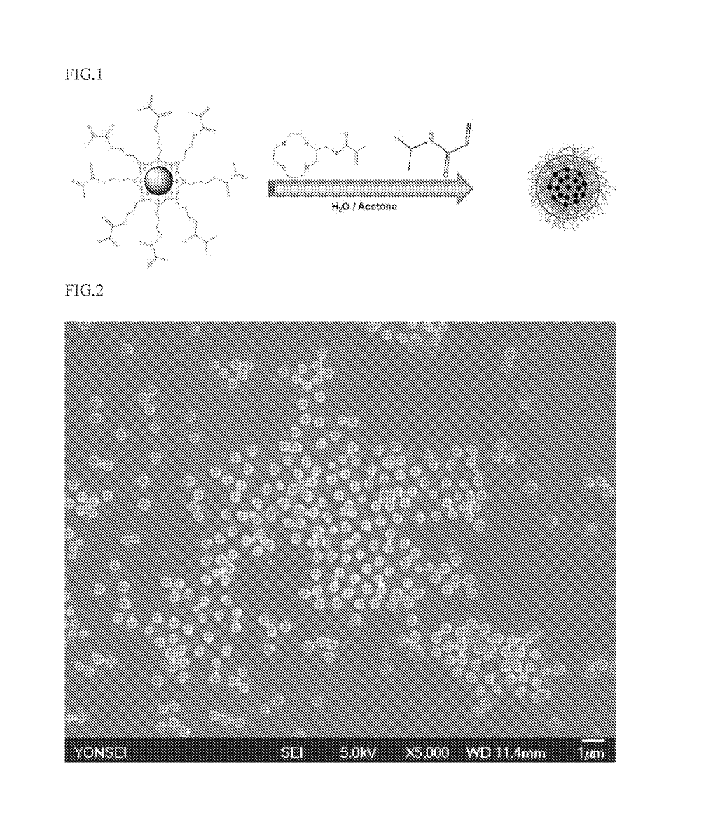

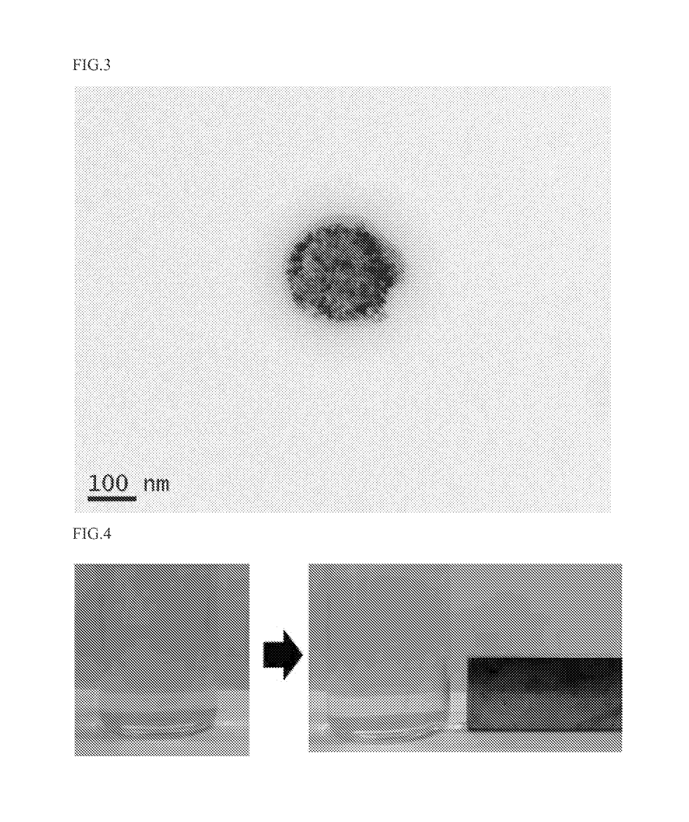

FIG. 1 schematically illustrates the process of preparing the organic-inorganic nanocomposite of the present application. Furthermore, FIG. 2 illustrates an electron microscope photograph in which the prepared organic-inorganic nanocomposite was observed, and FIG. 3 is a magnified view thereof.

### EXPERIMENTAL EXAMPLE 1

### Confirmation of Magnetism

The magnetism of the prepared organic-inorganic nanocomposite was measured by using a superconducting quantum interference device magnetometer (SQUID, MPMS XL5, and Quantum Design), which is a type of a highly sensitive magnetometer.

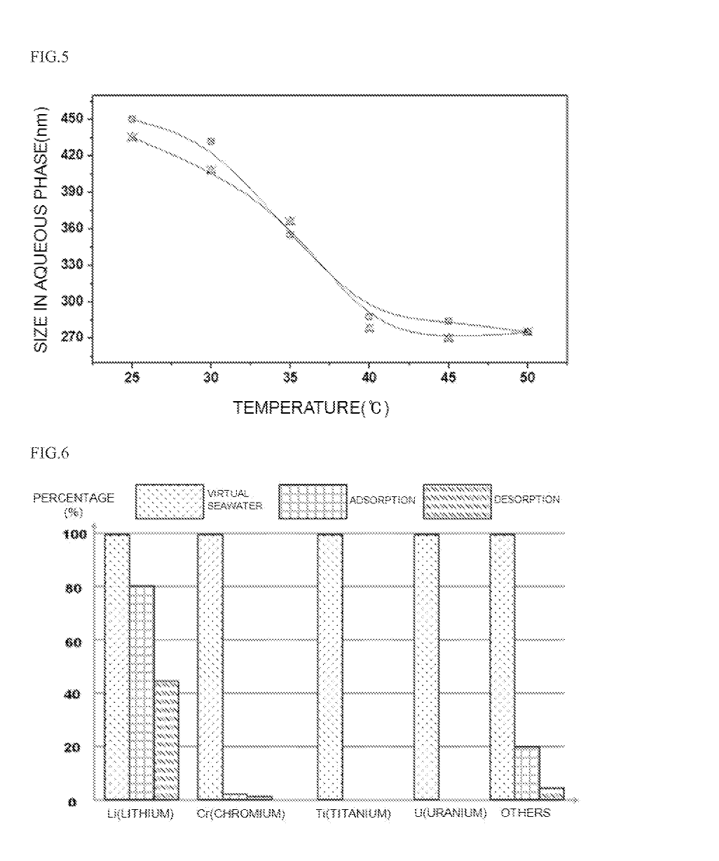

As illustrated in FIG. 4, as a result of reaction by using a permanent magnet due to the properties of magnetic particles having paramagnetic characteristics, it could be confirmed that the organic-inorganic nanocomposite dispersed in the solution was reacted and drawn to be attached onto the wall surface.

### EXPERIMENTAL EXAMPLE 2

### Confirmation of Change in Volume

A dynamic light scattering nanoparticle analyzer (DLS, Zetasizer nano ZS, Malvern, USA) was used to measure a change in size of the organic-inorganic nanocomposite.

As illustrated in FIG. 5, it could be seen that the organic-inorganic nanocomposite had a size of about 450 nm at room temperature, and exhibited a size of about 270 nm at approximately 50° C. when the temperature was increased.

### EXPERIMENTAL EXAMPLE 3

### Confirmation of Adsorption and Desorption

The organic-inorganic nanocomposite was used to perform analysis by using an inductively coupled plasma mass spectrometer (ICP-Mass Spectrometer (PERKIN-ELMER SCIEX (USA), ELAN 6100 (2002))).

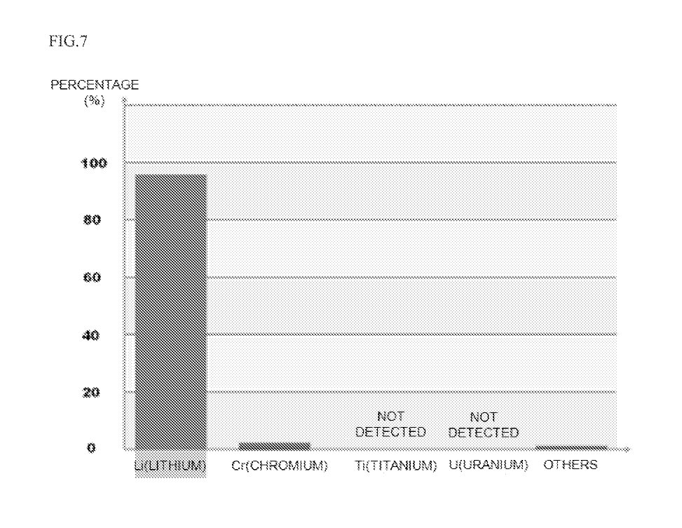

First, 3 g of a reef crystals reef salt (Aquarium Systems, Inc.) was dissolved in 100 g of distilled water, and then the remaining undissolved salt was filtered with a filter paper to prepare a virtual seawater solution. Thereafter, the organic-inorganic nanocomposite was added thereto, the resulting mixture was stirred for 1 hour, the amount of metal ions adsorbed on the nanocomposite from the virtual seawater was measured through the centrifuge, and the selectivity for the corresponding metal was calculated therefrom. The nanocomposite was again subjected to centrifuge process at 50° C. to measure the amount of metals desorbed. The result of measuring the amounts of the metal component adsorbed and desorbed is illustrated in FIG. 6. Furthermore, the selectivity for each metal was calculated, and the result thereof is illustrated in FIG. 7.

Referring to FIG. 6, it could be seen that about 80% of lithium ions contained in the virtual seawater were adsorbed. Furthermore, through the desorption process, about 48% of lithium ions were desorbed. Further, referring to FIG. 7, the selectivity for lithium ions was shown to be as high as 96% compared to those of the other metal ions.

The organic-inorganic nanocomposite according to the present invention can adsorb and desorb metal ions more rapidly, and can be utilized as a metal ion adsorbent having various forms.

What is claimed is:

1. An organic-inorganic nanocomposite comprising:
a polymer having temperature dependent volume phase transition characteristics; and
magnetic particles embedded in the polymer.

2. The organic-inorganic nanocomposite of claim 1, wherein he polymer is one or more selected from the group consisting of an amide-based polymer and an acrylic-based polymer.

3. The organic-inorganic nanocomposite of claim 1, wherein the polymer is one or more selected from the group consisting of N-isopropylacrylamide, N-isopropylmethacrylamide, N-n-propylacrylamide, N-tertbutylacrylamide, dimethylaminopropyl methacrylamide, N,N-dimethylacetamide, dimethylacetamide, ethanamide, acetamide, phosphonamide, sulfonamide, N,N-dimethylformamide, and derivatives thereof.

4. The organic-inorganic nanocomposite of claim 1, wherein the polymer having temperature dependent volume phase transition characteristics further comprises a selective adsorption functional group for metal ions, wherein the selective adsorption functional group is copolymerized with the polymer.

5. The organic-inorganic nanocomposite of claim 4, wherein the selective adsorption functional group for metal ions is one or more selected from the group consisting of 15-crown-5-ether, 18-crown-6-ether, 12-crown-4-ether, 24-crown-8-ether, and derivatives thereof.

6. The organic-inorganic nanocomposite of claim 1, wherein the magnetic particle is a metal, a magnetic material, or a magnetic alloy.

7. The organic-inorganic nanocomposite of claim 6, wherein the metal one or more of Pt, Pd, Ag, Cu, and Au,
the magnetic material is one or more selected from the group consisting of Co, Mn, Fe, Ni, Gd, Mo, MM′₂O₄, and MₓO_{y} (M and M′ independently denote Co, Fe, Ni, Mn, Zn, Gd, or Cr, and 0<x≦3 and 0<y≦5), and
the magnetic alloy is one or more selected from the group consisting of CoCu, CoPt, FePt, CoSm, NiFe, and NiFeCo.

8. The organic-inorganic nanocomposite claim 1, wherein an average diameter of the magnetic particles is 3 nm to 25 nm.

9. The organic-inorganic nanocomposite of claim 1, wherein an average particle size of the organic-inorganic nanocomposite is 100 nm to 100 μm.

10. A method for preparing an organic-inorganic nanocomposite, the method comprising:
preparing magnetic particles; and
preparing a polymer having temperature dependent volume phase transition characteristics, in which the prepared magnetic particles are embedded.

11. The method of claim 10, wherein the preparing of a polymer haying temperature dependent volume phase transition characteristics, in Which the prepared magnetic particles are embedded, comprises mixing and polymerizing
magnetic particles;
one or more selected from the group consisting of a vinyl-based monomer and an acrylic-based monomer; and
one or more selected from the group consisting of a cross-linking agent, an emulsifier, a dispersion medium, and a polymerization initiator.

12. An adsorbent comprising the organic-inorganic nanocomposite of an one of claims 1 to 8.
